(19) United States
(12) Patent Application Publication
(10) Pub. No.: US 2002/0120571 A1
(43) Pub. Date: Aug. 29, 2002

(54) Wireless financial system

(76) Inventors: David Maung, Del Mar, CA (US); Randy Salo, San Diego, CA (US)

Correspondence Address: PILLSBURY WINTHROP LLP, 725 South Figueroa Street, Suite 2800, Los Angeles, CA, 90017-5406, US

(21) Appl. No.: 09/792,882

(22) Filed: Feb. 23, 2001

(51) Int. Cl. G06F 17/60

(52) U.S. Cl. 705/42

(57) ABSTRACT

A system for enabling wireless interaction between a user of a wireless device and a financial institution is provided. The preferred embodiment comprises three layers, namely a presentation layer, a business logic layer, and a data access layer, each manipulating or accessing data and passing said data in a preferred format to the other layers irrespective of the wireless device used or the financial institution queried. The presentation layer receives the user request, makes appropriate requests of the financial institution through the business logic layer, obtains the financial information using the data access layer, and returns the financial information to the user over a wireless network. A user can employ various wireless devices to interact with the network, including but not limited to cellular telephones, PDAs, and laptop computing devices. The entire transaction is provided in a secure environment.

### BACKGROUND OF THE INVENTION

1. Field of the Invention

The present invention relates generally to wireless financial transactions, and more specifically to a system for providing wireless access to and control of financial information maintained by a financial institution.

2. Description of the Related Art

Financial services are currently offered over the internet to the general population through the financial institutions themselves, or through some type of intermediate service or portal, such as Yahoo! Recent developments in access to financial institutions over the internet include access to personal account financial data, the ability to pay bills, and the ability to trade stocks. Each of these services provide access and tracking of financial positions using secure means of communication over the internet, such as SSL. For internet banking, the user can monitor his or her bank balance, recent transactions, and transfer money between accounts. Bill payment entails the bill paying entity making a payment at a predetermined time based on user authorization and debiting the amount from a designated user account. Stock trading permits the user to view his or her account details and buy or sell stocks, mutual funds, bonds, options, or other financial instruments either when the money is available or on margin from the brokerage entity. Each of these transactions is enabled by fetching the appropriate data from the financial institution (brokerage, bank, credit union, bill payment entity) and relaying that data back to the user, and permitting the user to execute some level of functionality on the data where applicable, such as executing a trade, transferring money between accounts, and so forth.

While this functionality is now becoming widely available, at the same time users have access to certain information using various types of devices, including cellular telephones, PDAs, laptop computers, two way paging devices, and Microsoft Windows CE devices. Users can access certain information using these devices over the Internet, such as accessing stock quotes, sports scores, and other limited information.

At the present time, however, there is no simple and efficient way for a user having access to these various wireless devices to have access to his or her financial information, perform financial transactions, or obtain certain financial information, such as account balances, and so forth. The reasons for this inability to obtain personal financial information over wireless networks varies, but a part of the problem has been that until now financial institutions have not seen the need nor recognized the potential market for offering wireless financial services to their customers. Certain complexities exist, such as how to present this financial data to a user across different platforms in an efficient manner, and how to provide this information and functionality quickly and securely to a user.

Additional problems exist with providing financial services to users of various wireless devices. Users frequently have access to different devices among those previously noted, where each device has different data access abilities and requirements. For example, certain cellular telephones have speed dial or commonly called telephone numbers, but do not have the ability to receive e-mail. Certain cellular telephone handsets have the ability to receive alphanumeric pages, but some cellular service providers do not support this feature while others do. Also, many PDAs do not have the ability to receive over-the-air transmissions, but can synchronize with a database, such as a database associated with a personal computer and/or network, while other PDAs have the ability to receive and edit e-mail messages. Hence the ability for a user to access, maintain, and dynamically utilize financial information is heavily dependent on the input device employed by the user.

Further, while certain systems address the need to provide financial information to wireless users, such as concurrently filed U.S. Patent Application entitled “Financial Institution Wireless Internet System and Method,” to inventors David Maung and Eric C. Santos, such a system can benefit from the ability to handle more clients per device and the ability to be rapidly scaled and deployed. Further, new financial applications such as stock trading, virtual shopping carts, and the like require specialized functionality for the full financial experience. Further, the presentation capabilities of wireless devices continue to improve. Enhanced presentation capabilities would provide a distinct benefit, particularly the ability to separate and distribute the presentation functionality from the remaining tasks.

It is therefore an object of the present invention to provide a system enabling wireless access to financial institutions that is reasonably secure, fast, and enables transactions frequently requested of financial institutions.

It is a further object of the current invention to provide a wireless financial services access system that supports a variety of wireless devices, including PDAs, laptop computers, two way pagers, and Microsoft Windows CE devices.

It is another object of the present invention to provide a wireless financial services access system that is easily implemented and maintained, is scalable and dynamic, and does not require extensive maintenance or updating by the financial institution.

It is yet another object of the current invention to provide an extensible, scalable architecture that can be rapidly deployed and distributed over a variety of potential environments.

It is still another object of the current invention to provide a system addressing various financial applications and extensible to new designs, without the need for full system redesign when new functionality is required.

It is still another object of the current invention to provide a system having wireless device presentation capabilities that are extensible and able to be readily altered without altering the remainder of the system.

### SUMMARY OF THE INVENTION

According to the present invention, there is provided a system and method for enabling wireless interaction between a user of a wireless device and a financial institution. The preferred embodiment comprises three layers, namely a presentation layer, a business logic layer, and a data access layer, each manipulating or accessing data and passing said data in a preferred format to the other layers irrespective of the wireless device used or the financial institution queried. The business logic layer receives the user request, makes appropriate requests of the financial institution through the data layer, formats the financial information using the presentation layer, and returns the financial information to the user over a wireless network. A user can employ various wireless devices to interact with the network, including but not limited to cellular telephones, PDAs, and laptop computing devices. The entire transaction is provided in a secure environment.

The design of the present system provides for simple integration and modular upgrades without adverse effects on other portions of the system. Data obtained may include banking data, trading data, bill payment data, or other financial information and transactions involving all of this data are made available to the user's device. The business logic layer operates on and retrieves and transmits the requested information, while the data layer obtains the data necessary to perform the requisite functions. The presentation layer presents the data to the user in a device compliant format.

The business logic layer operates using XML, and financial data is obtained using any known electronic format or any custom format provided by the financial institution, with the ability to receive data in HTML format in the form of web pages containing the relevant financial information. The system parses the relevant financial information using the data access layer and transmits the converted information to the presentation layer. In the case of web pages, the data access layer converts HTML to a common format, typically XML, and operates on the XML code received.

These and other objects and advantages of all of the aspects of the present invention will become apparent to those skilled in the art after having read the following detailed disclosure of the preferred embodiments illustrated in the following drawings.

### DESCRIPTION OF THE DRAWINGS

FIG. 1 illustrates a conceptual drawing of a possible implementation of the present system wherein an operations center is used;

FIG. 2 is the present invention;

FIG. 3 represents the request handler operational scenario from a customer submitting a request through receipt by the customer of a returned value;

FIG. 4 illustrates a GetBalance operational scenario;

FIG. 5 is a Transfer operational scenario;

FIG. 6 is a GetHistory operational scenario;

FIG. 7 shows a MakePayment operational scenario;

FIG. 8 presents a DeletePayment operational scenario;

FIG. 9 is a ModifyPayment operational scenario;

FIG. 10 shows a GetPaymentList operational scenario;

FIG. 11 is a Login operational scenario;

FIG. 12 presents ChangeHistoryRange operational scenario;

FIG. 13 is a ChangePIN operational scenario;

FIG. 14 shows a ChangeTimeout operational scenario;

FIG. 15 is an application state diagram for the current system;

FIG. 16 is the Class Design for the present system;

FIG. 17 shows the PLIParser detail; and

FIG. 18 presents the OFXParser detail.

### DETAILED DESCRIPTION OF THE INVENTION

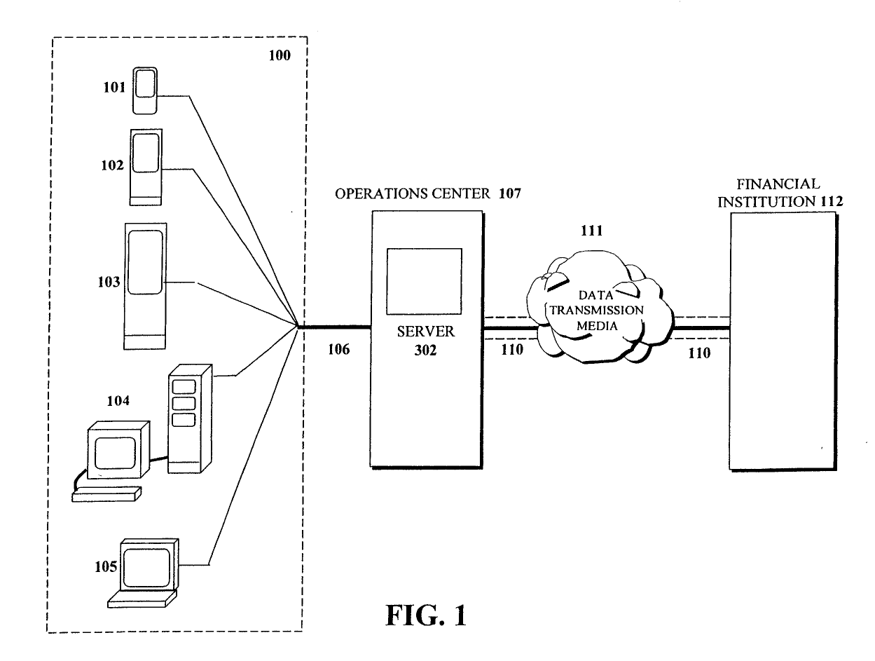

Referring now to the drawings, FIG. 1 illustrates a conceptual overview of the various articles between a user's wireless device and the financial institution.

From FIG. 1, a subscriber has access to an input device, which may be one from a class of input devices 100 including, but not limited to, a cellular telephone 101, a personal digital assistant (PDA) 102, a Microsoft Windows CE device 103, a desktop personal computer 104, or a laptop personal computer 105. Other devices may be employed, such as a two-way paging device, while still within the scope of the present invention.

The input device transmits or receives information over a data link 106, such as a telephone line, dedicated computer connection, satellite connection, cellular telephone network, the Internet, or other data connection. The data link 106 is connected to an operations center 107, which offers a central location for accessing and processing information from various remote financial institutions 112. Operations center 107 provides users with access to financial information or data maintained at the financial institutions 112. The operations center 107 transmits data through a dedicated connection 110, which is preferably an IPSEC tunnel through the Internet, or a PPTP connection via the Internet. The dedicated connection 110 is provided through data transmission media 111, which may be the Internet, a Wide Area Network (WAN), or any other media used for server communication. The dedicated connection 110 provides the robustness necessary to update the subscriber and provide information in a reasonable time period. Use of a connection that is not dedicated can result in delays and service disruptions, and the Internet provides an example of a powerful and readily accessible data transmission media. Addition of financial institutions 112 or operations centers 107 to an arrangement employing the Internet is relatively simple. Note also that data link 106 may also employ the Internet for user access to the operations center 107.

In operation, the user must first access the operations center 107 using an access arrangement, such as a password verifying his or her identity and pertinent information, such as a bank or brokerage account number. The user makes a request into the subscriber device, such as a cellular telephone, to view financial data, such as his or her bank balance in a particular account. The server 108 receives the request via the data link 106 and passes the request through the dedicated connection 110 and on to the financial institution 112. The financial institution 112 processes the request for the bank balance and obtains the necessary data. The financial institution 112 obtains the requisite information and transmits the data back through the dedicated connection 110, to the operations center 107, and to the user via data link 106 to the requesting input device. To accomplish this, the financial institution 22 must include a server having a scalable, reliable and secure data access platform, such as Microsoft Exchange Server, for ready access to the requested financial information.

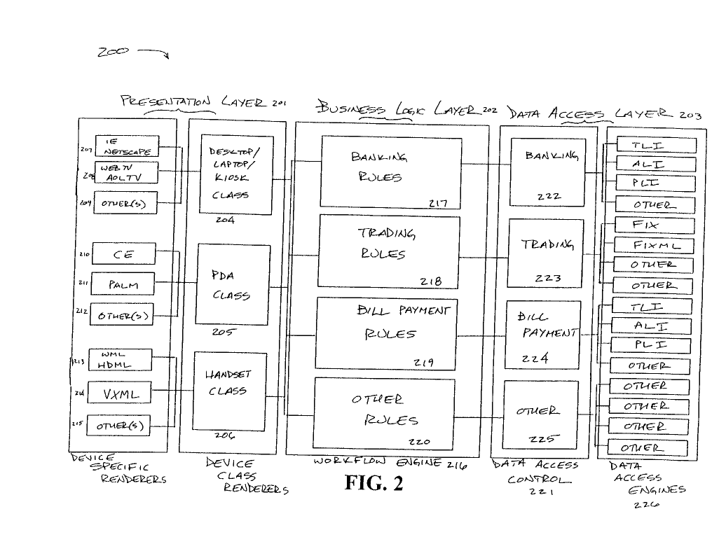

The system disclosed herein is presented in FIG. 2. From FIG. 2, the system 200 comprises a first Presentation Layer 201, a Business Logic layer 202, and a Data Access Layer 203. Presentation Layer 201 includes multiple device specific rendering items directed to various devices. The business logic layer 202 includes a programmable workflow engine 216 containing multiple business rule engines 217-220. The programmable workflow engine determines which data layer will handle the user request and what calls to the data layer are necessary. It then calls the data layer, aggregates the results, and forwards them to the presentation layer to be formatted for the device. Data access module 221 resides in the data access layer 203 and performs the function of providing access to the requisite data. Once the system, specifically the business logic layer, requests the necessary data, the data access control module 221 seeks the information from the financial institution and forwards the information to business logic layer. The data access module 221 interfaces with the data access engines which perform the actual retrieval of the information. Data access control module 221 includes various submodules divided on the basis of, and include banking data access module 222, trading access module 223, bill payment access module 224, and other access module 225. These data access modules interface with specific components of the data access engines, namely a group of banking data engines, trading data engines, bill payment data engines, and any other format data engines. The purpose and functionality of the data engines is to obtain information in a known format or conforming to a known protocol and return it to the business logic in a standard XML format If the data obtained from the financial institution is in the form of an HTML page, this HTML is converted into XHTML before being parsed into the standard XML used in the business logic layer and the presentation layer. TLI, PLI, and ALI, represent the form of the data from the financial institution and the type of conversion process necessary to change the data from the form offered by the financial institution to the preferred format used in the system, typically XML. For PLI, the data is in a presentation format at the financial institution and is converted from HTML to XML. TLI may represent translation from OFX, or Open Financial Exchange format, to XML, while ALI is a custom integration used to convert from a bank custom format to XML. For the trading route, data is obtained using FIX, or financial information exchange, and conversion of FIX data to XML data is performed by the Data Access Control layer, which represents the type of data cached therein. FIXML is the XML version of the Financial Information Exchange format. For each institution, particularly if the data is obtained from a web page or pages, specific style sheets representing the organization of the web page and the location of relevant information (bank balance, last items cleared, and so forth) are provided to the Data Access Layer.

The current design enables compartmentalizing the tasks associated with obtaining the necessary information, namely data access, business logic, and presentation. Changes at one layer do not affect changes at another layer, and addition of different components, such as new financial institutions or new types of wireless devices require fewer changes than previously realized. For example, if a new device type is added, functionality is added in the presentation layer and the business logic layer and data access layer are not affected. The system translates information and makes information available to other layers in a generalized format, such as XML, that permits conveyance of information and alteration or addition of components of the system without adversely impacting the other portions of the system.

Further, while the drawing of FIG. 1 represents a conceptual representation of one embodiment of the invention, it is recognized that components of the system of FIG. 2 can be located in various locations, with or without the need for an operations center. For example, the business logic layer and the data access layer may be located at the financial institution.

In operation, the user initiates a session on his or her wireless device by connecting through the business logic layer to the financial institution, which involves the use of passwords, keys, digital certificates, or other access methods mandated by the financial institution to verify the identity of the user. The user then initiates a request, such as a request for a bank balance. The business logic layer, specifically the programmable workflow engine, recognizes the request for a bank balance based on the XML code received and applies a set of banking rules to the request The business logic layer calls the appropriate data layer one or more times to obtain the requested information. Once the data has been obtained from the financial institution, the data is converted from the format in which it is maintained to XML format, which can require HTML to XML conversion. This conversion is done in the data access layer, specifically by the data access control modules, such that data emanating from the data access control modules is in XML format. Once the data is returned to the business logic layer, the business logic performs any necessary steps needed to provide the data to the presentation layer.

The system also handles cookies received from the financial institution. Cookies received as part of an HTTP header are parsed in the Data Layer and stored in the session information. These cookies are returned to the financial institution on the client's behalf the next time the client makes a request. In operation, the business logic layer works as follows. The Business Logic Layer controls the flow of the application and coordinates the activities of the other layers. The business logic receives the user request, translates that request into one or more calls to the data layer to acquire the requested information, formats the results for output via the Presentation Layer, and returns the result. The Business Logic performs five main functions. Business Logic handles incoming HTTP requests from the client. The Business Logic parses the request and may create a worker thread to perform execution. Business Logic also accesses financial institution properties to receive a list of data layer calls that will satisfy the client request. This method is used to create a dynamic method of implementing a diverse set of financial institutions for wireless service. The Business Logic communicates with the data layer(s) and aggregates the responses into a single XML tree. The Business Logic also passes XML information to the presentation layer along with device information. The presentation layer then returns output suitable for the client device. Finally, the Business Logic stores usage statistics, including the user's device ID, operation requested, date, and time.

Clients use a diverse set of devices, which communicate in SSL to the business logic host system. Each device will have different communications protocols and different display characteristics. The current expected device protocols are WML, HDML, and HTTP. Wireless device displays are expected to range from a few lines of less than 20 characters to full web browsers. The business logic determines the different types of devices, locates an appropriate style sheet for output rendering, and forwards these to the presentation layer.

The goal of the overall system is to provide an architecture in which it is easy to enable wireless access to financial information provided by a diverse set of institutions that have different communications protocols and interfaces. The business logic layer is responsible for controlling the flow of the application from the user request to the final response.

In the preferred embodiment, the Business Logic Layer is implemented on a Windows NT 4.0 platform, uses COM/DCOM technology, and is written in C++. Where XML parsing/authoring is required, this subsystem employs Microsoft's MSXML DOM Parser Version 3.0. Client devices communicate with the system via HTTP over SSL. This information will be received by IIS and passed to the application. The application will parse the incoming HTTP post to understand the user request.

A number of diverse devices will access the system. These devices are differentiated by browser type information included in the HTTP headers of the client request. The business logic layer determines the client device type and se this information to retrieve the proper financial institution pages.

The client request contains the client's desired financial institution information, such as a bank number, account number, or other relevant information. The business logic determines the financial institution the client wishes to use and obtains financial institution specific properties for the client request.

The data layer operations performed for each client request are determined by financial institution properties. This allows custom application flow for each financial institution. The business logic determines the requested client function based on information in the URL. The business logic then accesses the financial institution properties to determine the list of data layer operations satisfying the request. The business logic iteratively calls the data layer to perform each operation. During iterative calls to the data layer, the business logic maintains an XML tree which contains the aggregate results. If at any time, an error is reported, the iterative process will stop and the error will be sent to the presentation layer to be reported; otherwise, the business logic will aggregate all results from the client and forward the resulting XML tree to the presentation layer. After data is aggregated, the business logic sends the aggregate XML tree, the device type, and the appropriate style sheet to the presentation layer. The business logic sends an HTTP response to the client. Business Logic will set the appropriate MIME type for the device and forward the output generated by the presentation layer.

The business logic includes various classes of functionality. Class ISAPIController is the main class of the business logic. This class provides an interface to Microsoft IIS and isolates the rest of the application from IIS details. When an incoming request is received from IIS, Class ISAPIController spawns a worker thread and instantiate a RequestHandler to process the user's request. Class RequestHandler performs the work to satisfy the client request. Class RequestHandler instantiates a DataLayer object, a Presentation Layer object, and a Financial Institution Properties object. Class RequestHandler then controls the user request until it is handled. As part of its function, this Class receives the parsed user request. It parses the function requested from the user request string and obtains the list of data layer calls that will satisfy this request. Class RequestHandler then iteratively calls the data layer and aggregates the results until the request is satisfied. Next, Class RequestHandler passes the results, along with an appropriate style sheet, to the presentation layer for formatting and returns the result to the caller.

Class FIProperties maintains all of the FI (financial institution) specific information. Customization of a bank can be performed by modifying the information stored in FI properties. This class exposes FI properties to the rest of the application. This class returns a stylesheet used to format the results of the user request for output. The stylesheet is passed to the presentation layer.

The Presentation Layer formats the results of the client query for display on the device. It also displays any menus and user options. In the present system, the presentation layer is composed of two parts: an algorithm to generate device specific output from XML data and a stylesheet, and the contents of the stylesheets themselves. Most of the functionality of the presentation layer is contained in the stylesheets.

The Presentation Layer generates device specific formatting of financial institution output and presents a device specific user interface to the client, consisting of dialog boxes, menus, and so forth. Clients or users use a diverse set of devices, and each of these devices communicates in SSL to the host system. Each device has different communications protocols and different display characteristics. The current expected device protocols are WML, HDML, and HTTP. Wireless device displays are expected to range from a few lines of less than 20 characters to full web browsers. The presentation layer formats user output and menus appropriately for the client device. This presentation may be supplied in the form of unique stylesheets for each possible device. The presentation layer is responsible for managing the interaction with the client, including providing the user interface and appropriately formatting the output data.

The preferred embodiment of the Presentation Layer is implemented on a Windows NT 4.0 platform, uses COM/DCOM technology, is written in C++ and XSLT, and employs Microsoft's MSXML DOM Parser Version 3.0 where XML parsing/authoring is required.

The Presentation Layer transforms an XML tree which contains no presentation and a XSL stylesheet to device specific output. The Presentation Layer uses the MSXML DOM Parser Version 3.0 to accomplish this task. Microsoft Internet Explorer 5.0 is preferably installed on the server for the MXSML DOM Parser version 3.0 to be present.

The user or client connects to the system either by using a preprogrammed URL on the client device or manually typing in the URL. This URL contains the name of the institution the user wants to access. After the business logic verifies that the institution is supported, the presentation layer constructs a device specific login page. The processing employed is XSLT, where one XSL stylesheet represents login for each supported device.

After login, some financial institutions may present an account selection screen. If the business logic determines that an account selection screen is to be presented, the presentation layer generates a device specific account selection screen. One XSL stylesheet displays account selection for each supported device.

Either directly after login or after account selection, the user is presented with a main menu. This menu may contain a list of accounts and their balances (to provide summary information to the user without requiring extra server hits). The balance feature of the main menu may be implemented on some devices but not others. The presentation layer contains one XSL stylesheet representing the main menu for each device. On financial institution computing systems that show account balances separately rather than on the main menu, the presentation layer provides device specific balance pages. One XSL stylesheet representing balance exists for each supported device. The presentation layer provides an account details screen for each device. The account details screen contains account name, account number, account description, and account balance. One XSL stylesheet represents account details for each supported device.

The presentation layer also provide history pages, and the ability to scroll through the history. The number of transactions per page depends on the device. Again, one XSL stylesheet represents history for each supported device.

The presentation layer allows the user to perform a transfer of funds from one account to another. The presentation layer allows the client to enter the “from account”, the “to account”, and the amount to transfer. One XSL stylesheet represents transfer for each supported device.

The presentation layer further enables the user to initiate payments to pre-qualified payees. At a minimum, the presentation layer allows the user to select a payee, enter an amount, and set a payment date. Some financial institutions require supporting modification and deletion of scheduled payments. One XSL stylesheet represents bill pay for each supported device. Additional stylesheets represent modify and delete payment where necessary.

On occasion, business logic may find that an unexpected condition occurred that could not be handled through the normal processing pipeline. The presentation layer provides a default error handling stylesheet for these conditions or specific error handling stylesheets for different types of errors.

The presentation layer generates user interface elements through XSL stylesheets. Stylesheets are designed to be usable for the largest number of institutions and can be customized. The transformation engine of the presentation layer is a COM interface called from the business logic. The transformation engine receives an XML tree representing the current financial data and a XSL stylesheet for presentation. The transformation engine returns device specific output. Communications with the client employs IIS and the system is implemented as an ISAPI DLL.

The Presentation Layer implementation is divided into two portions, translation and stylesheets. Stylesheets are created using Extensible Stylesheet Language (XSL). The translation portion of the presentation layer is a single COM class that exposes a single method to the business logic. This method will accept a XML tree and a XSL stylesheet and returns a string containing the device specific output.

Class PLController represents the COM interface to the Presentation Layer. The purpose of this class is to generate device specific output. This class instantiates an MSXML DOM and populates the MSXML DOM with the XML tree. This class then passes the stylesheet to the DOM and performs translation. The resulting output is returned to the caller.

With respect to stylesheets, the client device should not be allowed to cache information. Some devices require that every output page include commands to turn off caching. Stylesheets include error handling. Further, after the login page, session information is maintained by returning the session ID in the URL. The session ID is returned with every request.

With respect to individual specific screens, the main menu may consist of four selections: Balance, Transfer, History, and Bill Pay. This menu should also be the destination of any canceled or completed operation. The user will be presented with a list of accounts. This menu may be presented before or after the main menu depending on the financial institution. An account balance page displays a list of accounts and their balances. This may be incorporated into the main menu, depending on the financial institution. An Account Details page displays all information about a specific account, including an account name, account number, current balance, and available balance. There may be an account description or other institution specific information. A history page contains a list of transactions for a specific account. The history range may be last 30 days, last calendar month, or some other institution specific range. If there are more transactions than can be displayed on a single history page, the history page provides the ability to scroll through the transactions. A transfer page permits the user to select a “from” account, a “to” account, and an amount. Some institutions incorporate a transfer verify page allowing the user a second opportunity to cancel. Information entered by the user is cleared and should not be cached on the next occurrence of the transfer operation. The Bill Pay page allows the user to select from a list of payees, enter an amount and a payment date. Information entered on this page is not cached. Two additions to bill pay are delete payment and modify payment. These present a list of scheduled payments and allow the user to select one to modify or delete. Error pages display a clear message describing the error condition. The user is directed to either the main menu or the first page of the function being attempted. Error pages clear device caches and stored variables where possible. Only timeout, critical errors, or user authentication errors return the user to the login screen.

The data layer retrieves financial information depending on the financial institution and the desired transaction. The data layer employs an API that requires one input parameter and returns one output parameter. xmlIn is an input string formatted as an XML document fragment. The document fragment contains all data necessary to denote the requested functionality to be executed as well as all parameter data necessary to execute that functionality. xmlOut is an output string formatted as an XML document fragment. The document fragment will contain status of the functionality invocation and any associated data.

Callers of the Execute method define the functionality they wish to execute by authoring a “request message” in XML format. The request message indicates the specific functionality being requested and any parameter data necessary to carry out the request. Similarly, the resultant status of the request and any associated data are returned in the output parameter as an XML formatted “response message”.

Request specifiers include, but are not limited to, Begin Session, End Session, Login, Logout, ListAccounts, CanTransferFrom, CanTransferTo, CanBillPay, GetHistory, GetPaymentList, GetPayeeList, CreatePayment, ModifyPayment, DeletePayment, TransferFunds, ChangeTimeout, and ChangePassword. Payment specifiers, such as CreatePayment, ModifyPayment, and DeletePayment, are used for those financial institutions having the ability to make bill payments, and these specifiers enable the user to interact with such services.

The data layer is primarily responsible for providing a common interface to the business layer for all financial institutions. Any information the business layer would have typically requested directly from a financial institution, it requests of the data layer. The data layer therefore exposes a compilation of banking functions for the business layer to call upon. This compilation is referred to as the Data Layer API. In addition to providing a common interface of requests to the business layer, the data layer also provides the response to those requests in a common format. This format is referred to as the Data Model. While the amount of data passed in to the data layer is relatively small, such as an account identifier, the amount of data passed back to the business layer as a result of the request may be substantial, such as all transaction records from the last month, and is almost always complex. With respect to the Data Layer, the Data Layer includes a Communication Manager data class, and various methods corresponding to the specifiers outlined above (DeletePayment, ChangeTimeout, and so forth). The Data Layer also recognizes different types of financial institutions, such as banks, credit unions, bill paying entities, and so forth. The CommMgr class is a virtual class representing the communication between the data layer and a financial institution. Classes which implement the CommMgr class provide definitions for all functions to effect communication with a financial institution or a group of financial institutions. One example of an implementing class is HTTPCommMgr for communication with web servers.

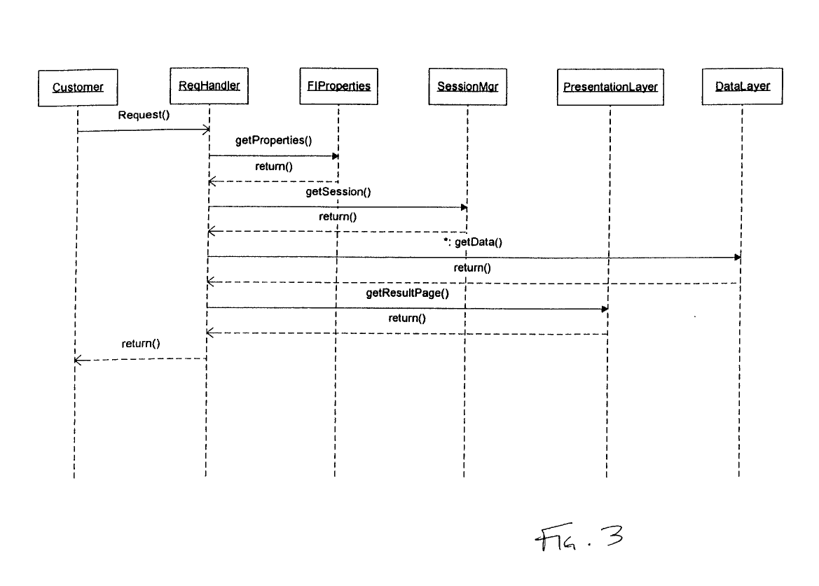

FIG. 3 illustrates a standard Request Handler scenario, with the interaction between a customer, client, or user, the Request Handler, the Financial Institution Properties, the Session Manager, the Presentation layer, and the Data Layer. A customer generates a request, and receives a return from the Request Handler based on the appropriate information obtained from the financial institution.

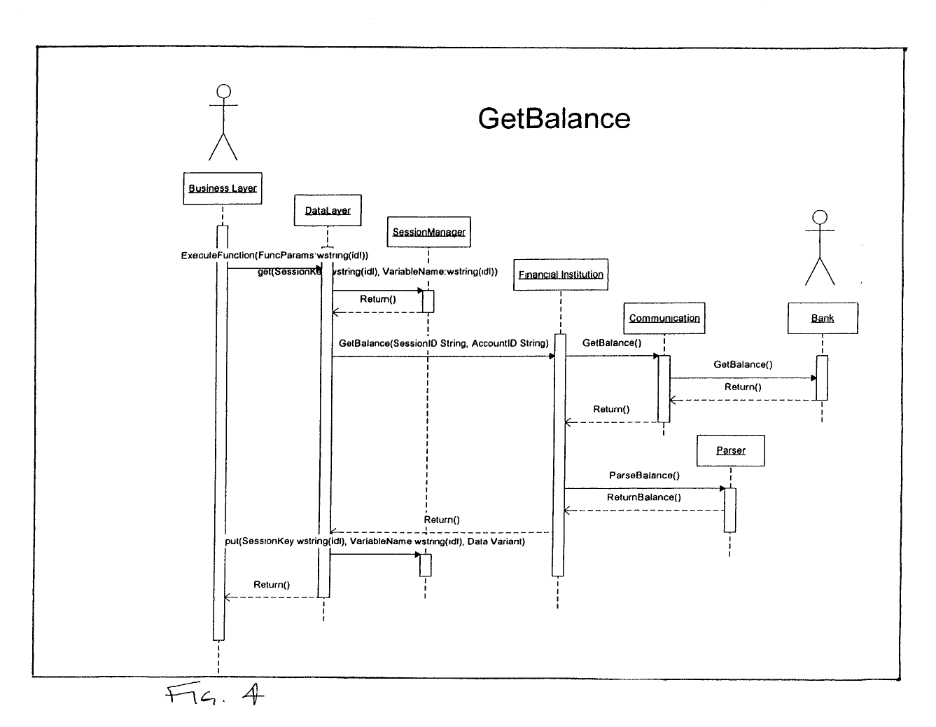

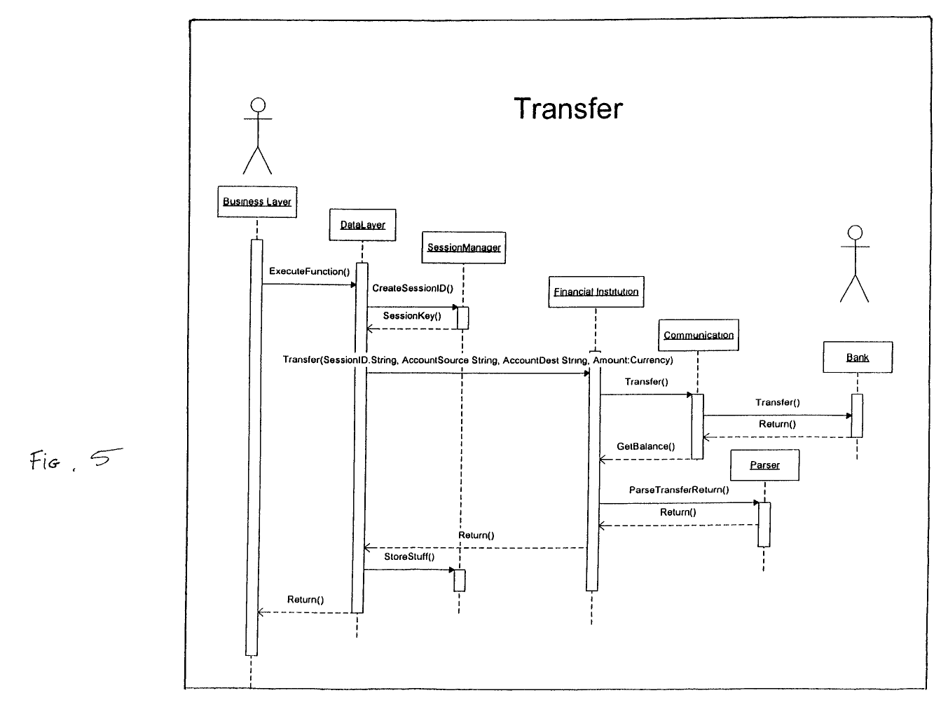

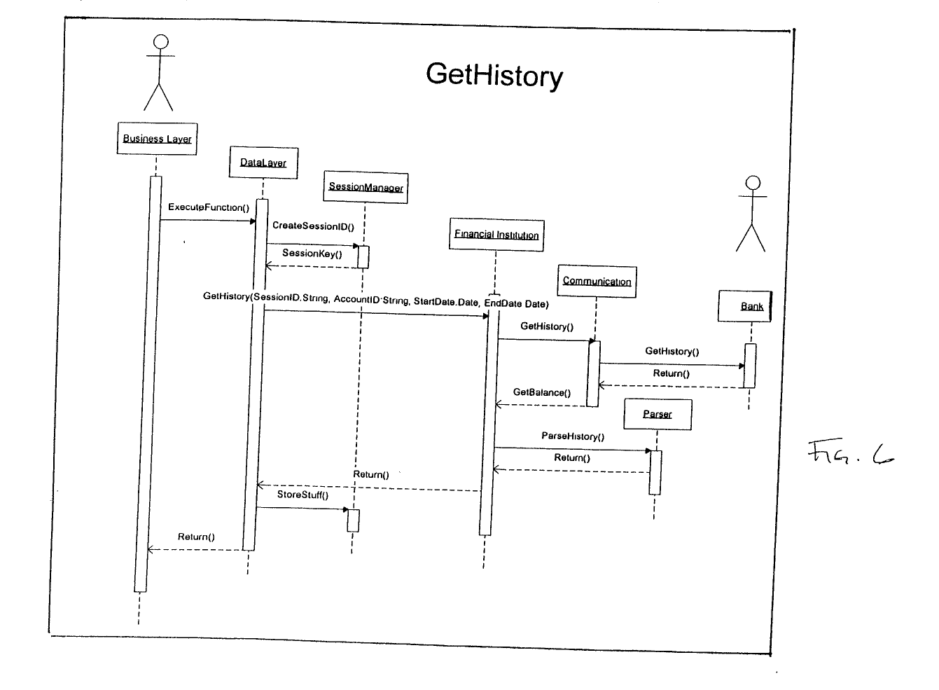

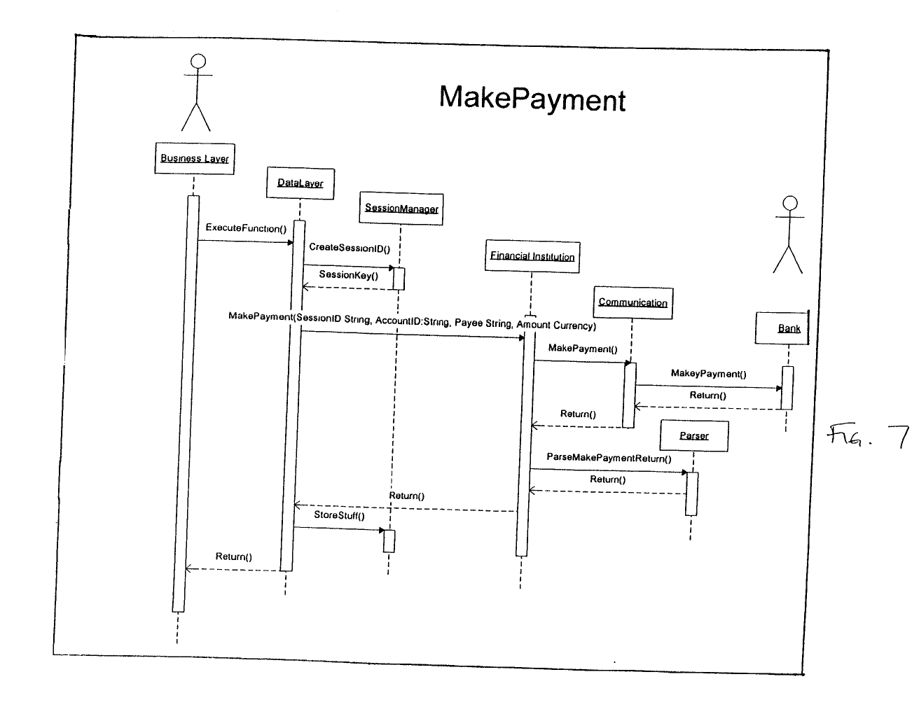

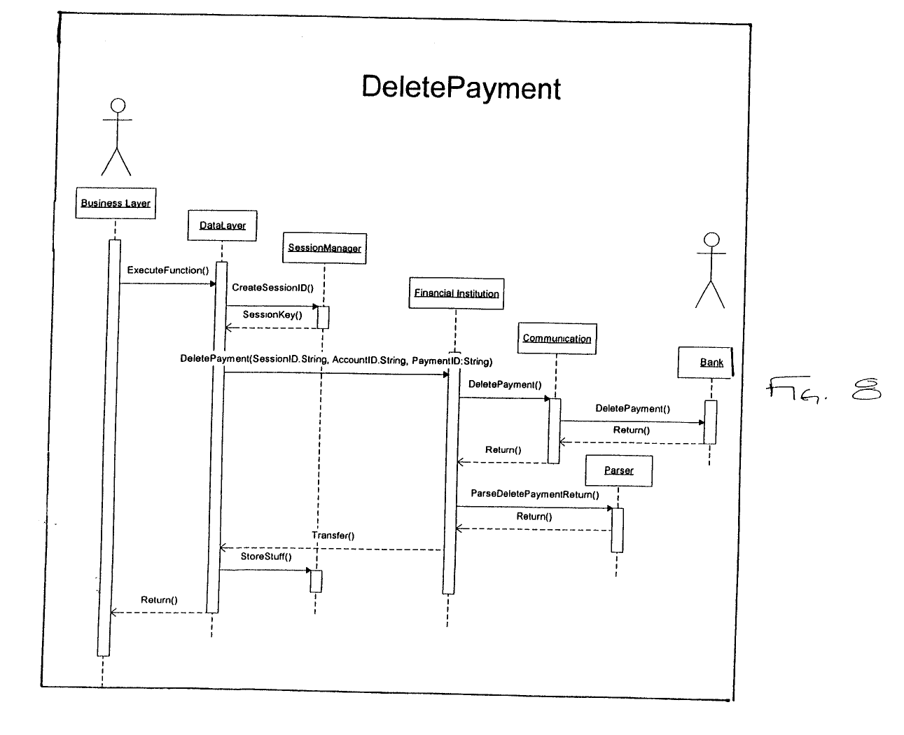

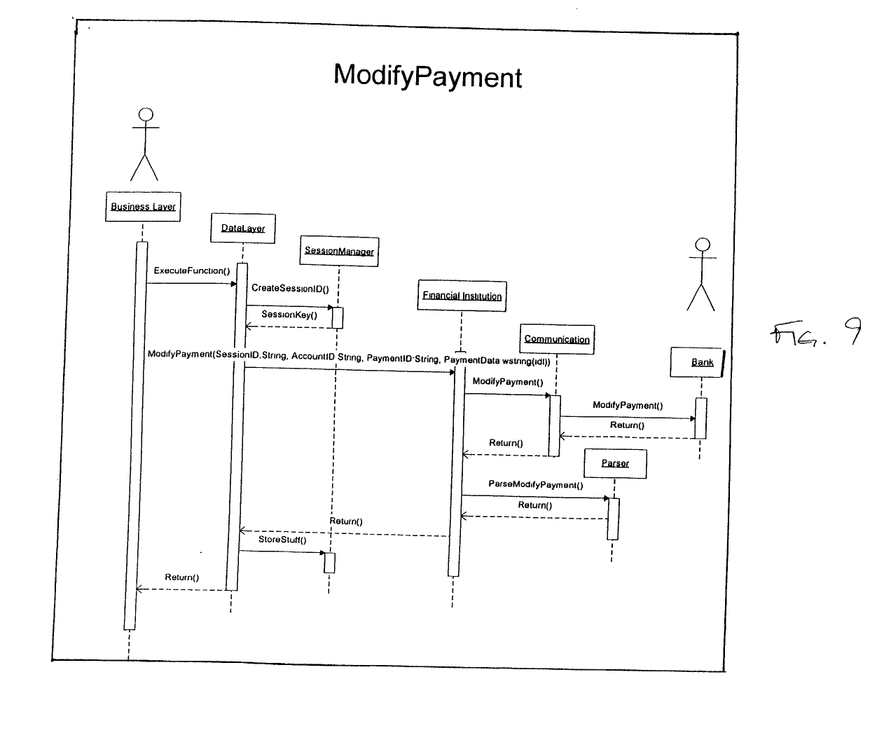

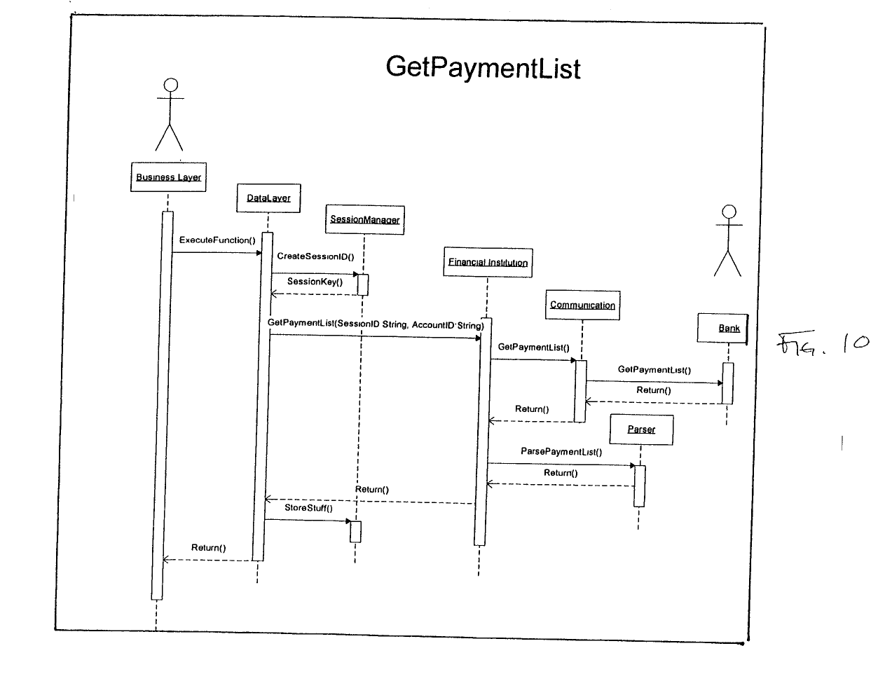

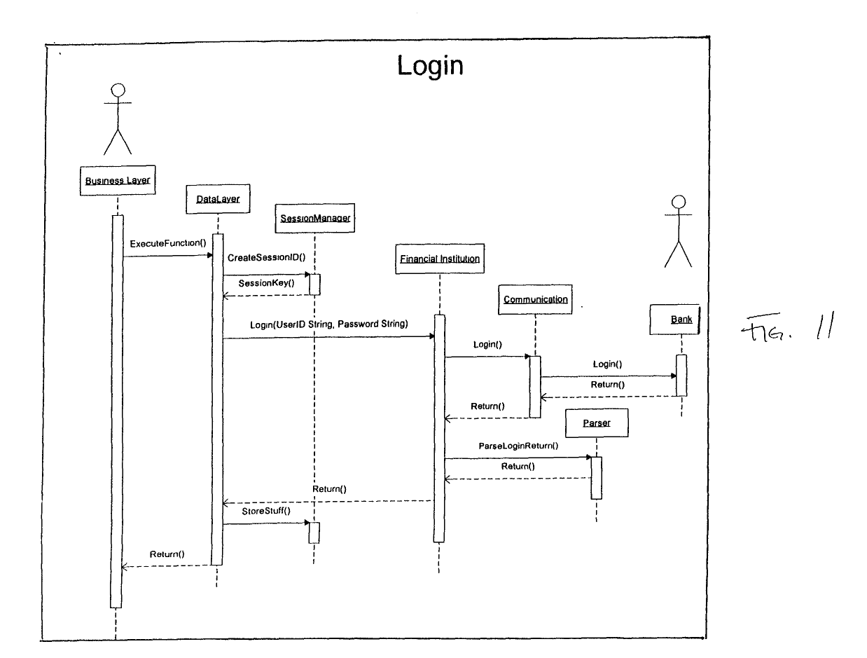

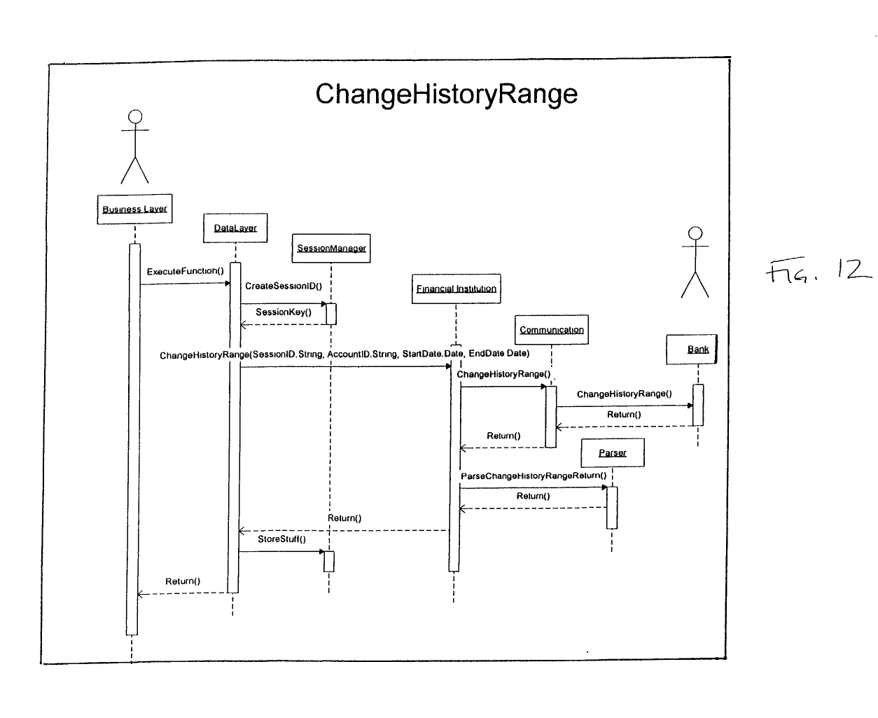

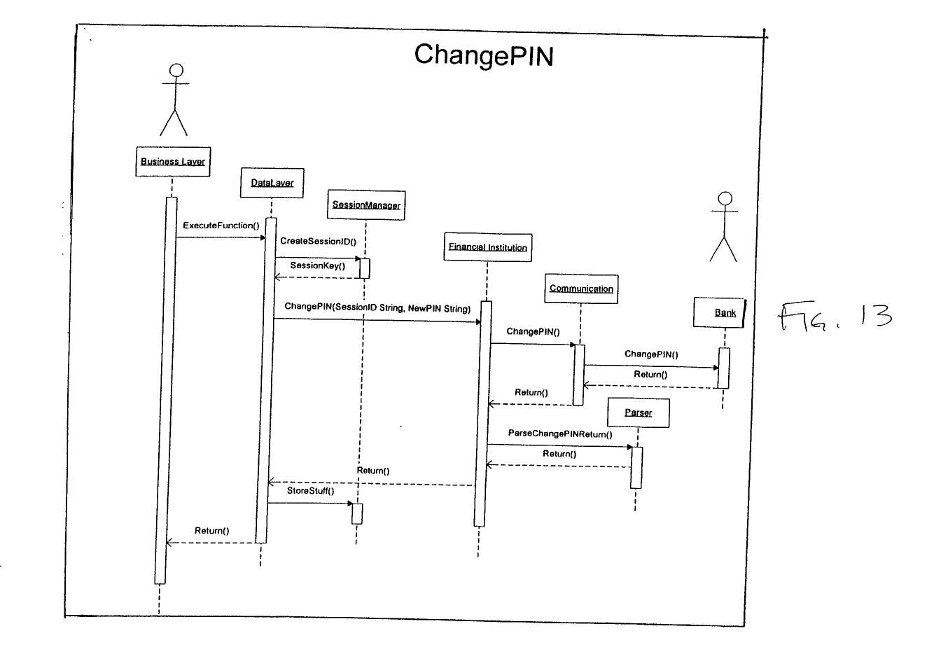

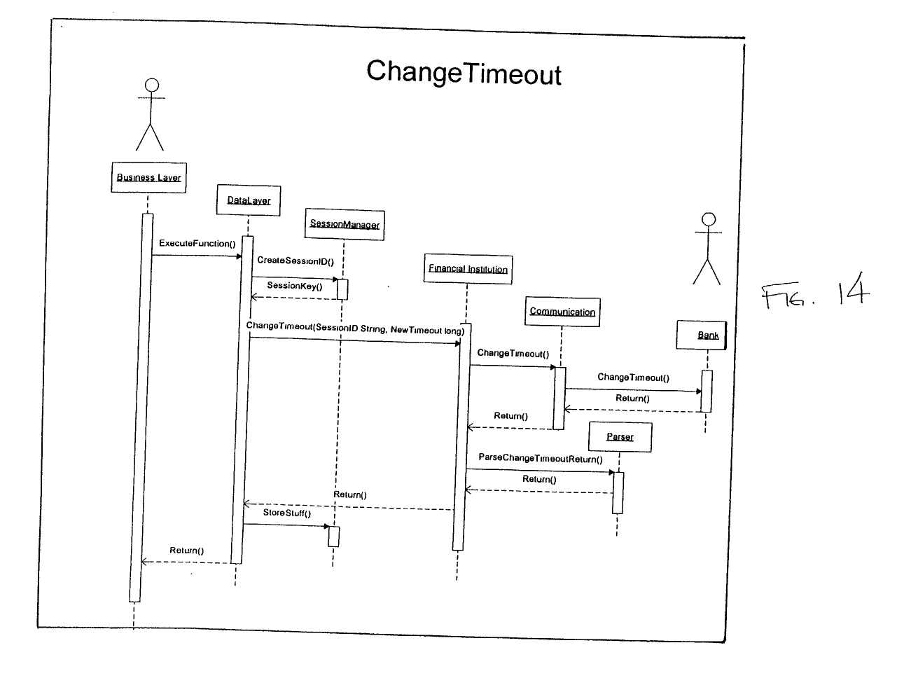

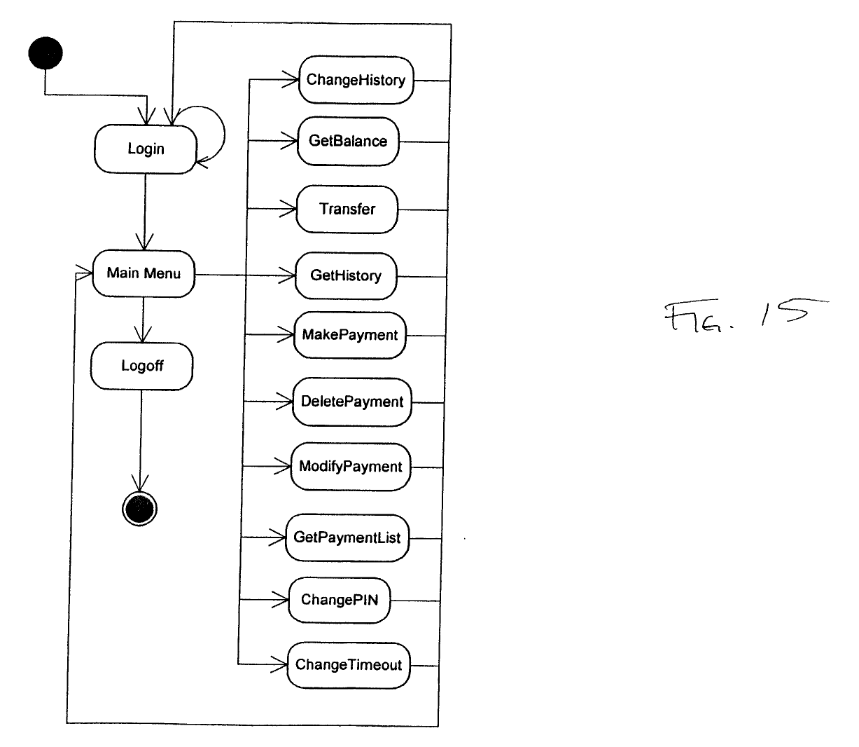

FIG. 15 presents an application state diagram for the current system, including login, access to main menu, the various operations available, and logoff. FIGS. 4 through 14 illustrate operational scenarios for the various functions performed by the system, from the user through to the financial institution and back to the user, including functions transmitted from the business logic layer to the data layer and back. The various functions presented, namely GetBalance, Transfer, GetHistory, MakePayment, DeletePayment, ModifyPayment, GetPaymentList, Login, ChangeHistoryRange, ChangePIN, and ChangeTimeout represent available functions and may be supplemented based on the desired functionality of the system. These functions form the basic connectivity to a financial institution, such as a bank, in the present system.

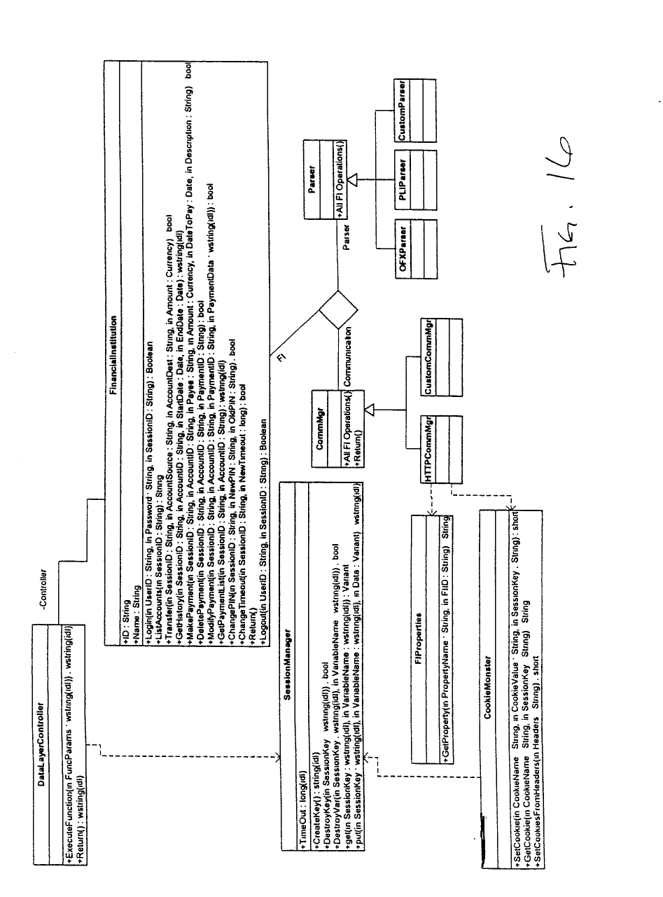

FIG. 16 shows the Class Design for the current system, including the use of communication managers, a parser, a cookie handling device, and a session manager. Details of the cookie handling device and session manager or saver are provided in concurrently filed patent applications assigned to SensCom, the assignee of the present application, and entitled “Financial Institution Wireless Internet System and Design,” inventors David Maung and Eric C. Santos, and “Unique Session Saver Design,” to inventor David Maung. Both of these applications in their entireties are incorporated herein by reference.

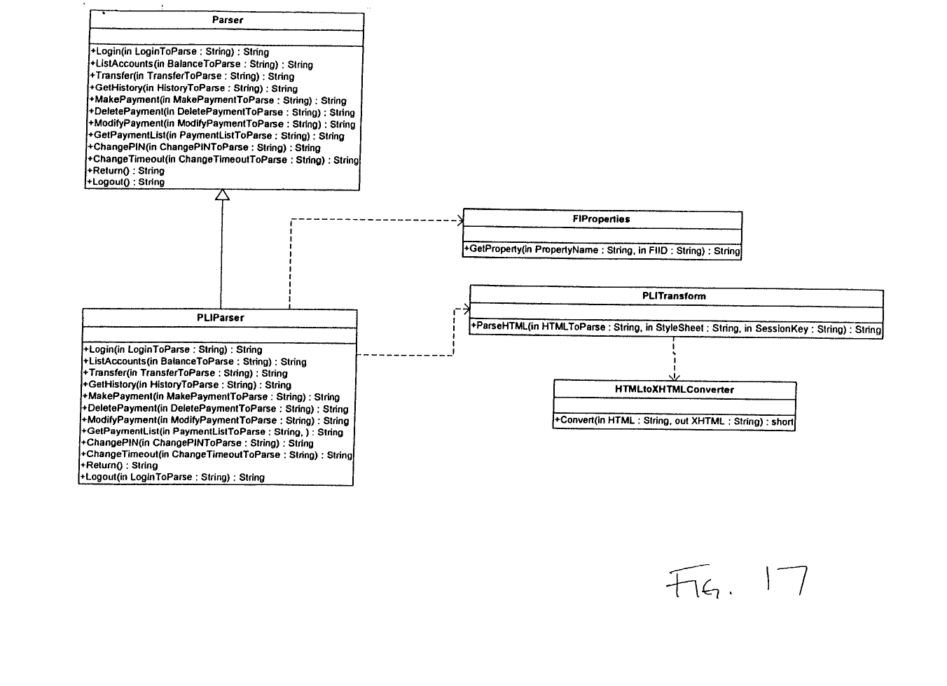

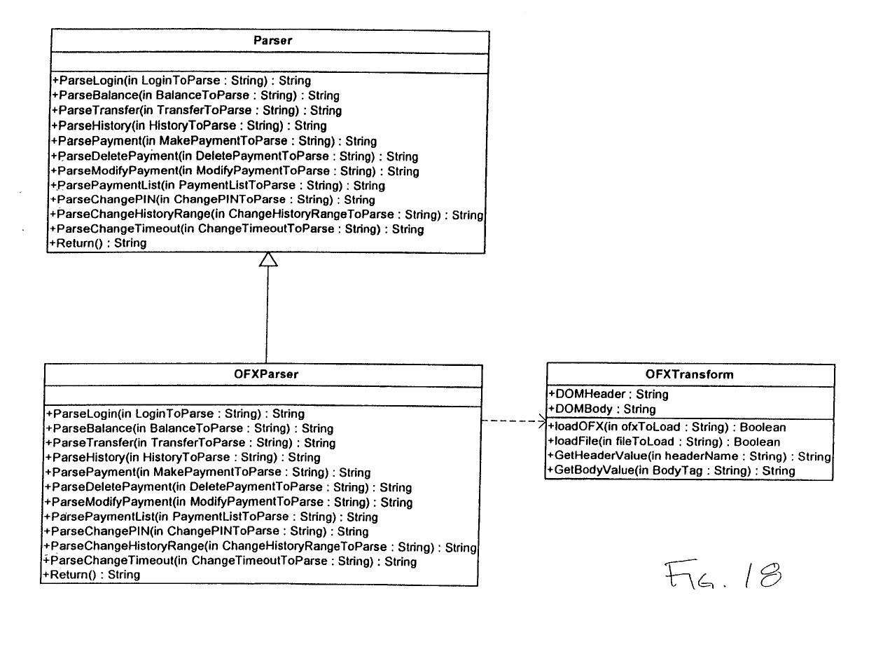

Details of the PLIParser design are presented in FIG. 17, including a general parser and associated code and the PLI parser with Financial Institution properties, PLI transform information and the HTML to XML conversion described herein. FIG. 18 shows the OFXParser detail, including the Parser code, OFXParser code, and OFXTransform code.

HTML to XML Conversion

The most time consuming implementation when bringing a new financial institution online is deciding how to parse HTML pages from the financial institution and extraction of the necessary financial information from those pages. This procedure is known as transcoding and is commonly referred to as “screen scraping.” The typical operation of transcoding involves reliance on the end user device to handle any HTML anomalies involved with the transmission of information, typically on a page by page basis.

Further, as noted above, every financial institution interfacing with the current system requires conversion of the data obtained from the financial institution's format to XML for use in the business logic layer. Thus it is necessary to quickly and efficiently convert HTML data to XML for use by the business logic layer, as many financial institutions are set up to provide secure data via web pages and HTML.

The present system employs XML for internal data structure and data sent to any receiving wireless device, such as a cellular telephone. The present system employs the XSLT transformation language to transform the XML internal data format to XML for display on wireless devices. Certain advantages exist in using XSLT to also transform the original HTML code into XML as well. However, XSLT does not accept poorly structured HTML. The document received by the XSLT engine must strictly conform to the XML specification. While XML and HTML have certain similarities, the HTML specification and the HTML standard is relatively relaxed by comparison to the XML counterparts. Thus the present system accepts HTML in any form, such as loose HTML conforming to the HTML specification, converts the HTML to well formed XML. The well formed XML is applied to an XSLT style sheet to extract the necessary data and generate the internal data structure.

Transformation of HTML into XML depends on the page being transformed. Financial pages can generally be converted to well formed XML by applying the following rules.

Addition of quotation marks

Attribute values reside in HTML without quotation marks. The present system locates attribute values and inserts quotation marks during the HTML to XML conversion.

Insertion of missing end tags

The present system inserts end tags to balance each start tag. The most commonly seen form of this anomaly are tags such as <br> that does not contain attributes or text. The system evaluates the specific section of HTML to determine the preferred location of the missing tag, and either changes the <br> tag to <br/> or adds the </br> tag to the end of the HTML.

Incorrectly nested end tags

Browsers permit an HTML page to have incorrect balancing, such as a beginning tag with a subsequent end tag simply occurring after the beginning tag. The XML specification does not permit this. XML requires each start tag to be nested completely inside its parent tag. Poor HTML nesting includes the following:

<i> Italicized Text <b> Bold Text </i> </b>

XML does not permit this nesting; the bold must end before the italics in this example. Thus the present system converts the aforementioned text to:

<i> Italicized Text <b> Bold Text </b> </i>

Once the system converts the web page using the aforementioned tasks, the system writes an XML style sheet for each page. The style sheets do not require recompiling the codebase.

It is to be understood that while FIG. 2 through 17 illustrate a preferred embodiment of the present invention, other implementations are possible of the novel concepts and functions provided herein while still within the course and scope of the present invention. While the invention has been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

What is claimed is:

1. A system for providing wireless device access to financial information maintained at a financial institution, comprising:
a presentation layer for preparing financial information presented in a standard format for display on an individual device;
a business logic layer controlling application flow using a workflow engine to make calls to receive financial information and to make calls to the presentation layer to generate device output; and
a data access layer for accessing financial data from financial institutions based on client requests;
wherein financial data accessed by said data access layer is passed to said business logic layer for relevant formatting of said data, to said presentation layer for rendering, and to said wireless device.

2. A system for providing financial data maintained at a financial institution to a wireless device user, comprising:
a data access layer having at least one data access engine for obtaining the financial data;
a business logic layer connected to said data access layer for receiving user requests and generating appropriate calls; and
a presentation layer connected to the business logic layer for formatting financial data in a device compliant format.

3. An apparatus for accessing data maintained by a financial institution via a wireless device by transmitting a request for accessing said data, comprising:
a business rule engine for receiving the request and developing a set of commands recognized by a data layer; and
a data access device for obtaining the data according to said set of commands, said data access device operably connected to said business rule engine.

4. A system for providing wireless device access to financial information maintained at a financial institution, comprising:
a presentation layer for preparing data to be presented to a user;
a business logic layer, comprising a workflow engine making calls to receive financial information and calls to the presentation layer to generate device output;
a data access layer for accessing financial data from said financial institution based on user requests;
wherein financial data accessed by said data access layer is passed to said business logic layer, to said presentation layer, and to a wireless device of the user.

5. A system for providing financial data maintained at a financial institution to a wireless device user, comprising:
a data access layer having at least one data access engine for obtaining the financial data;
a business logic layer connected to said data access layer for calling appropriate modules to act regarding the financial information sought; and
a presentation layer connected to the business logic layer for formatting the financial data in a device specific format.
